(19) United States
(12) Patent Application Publication
(10) Pub. No.: US 2018/0149488 A1
(43) Pub. Date: May 31, 2018

(54) GUIDE ROUTE SETTING APPARATUS AND GUIDE ROUTE SETTING METHOD

(71) Applicants: ALPINE ELECTRONICS, INC., Tokyo (JP); HONDA MOTOR CO, LTD., Tokyo (JP)

(72) Inventors: Shuichi Suto, Iwaki-city Fukushima (JP); Hitoshi Konishi, Wako (JP); Daichi Kato, Wako (JP); Chihiro Abe, Wako (JP); Shion Tokunaga, Wako (JP)

(73) Assignees: ALPINE ELECTRONICS, INC., Tokyo (JP); HONDA MOTOR CO, LTD., Tokyo (JP)

(21) Appl. No.: 15/818,483

(22) Filed: Nov. 20, 2017

(30) Foreign Application Priority Data
Nov. 29, 2016 (JP) 2016-231446

(51) Int. Cl. G01C 21/36; G08G 1/0968

(52) U.S. Cl. CPC G01C 21/3658; G08G 1/0968

(57) ABSTRACT

A guide route setting apparatus may include a lane-basis route setting unit configured to follow lane networks in a direction of a vehicle position from a starting point at an end of the lane networks and to set lane networks connecting from the end to a lane where the vehicle position presents a lane-basis guide route based on lane network data acquired by a lane network data acquisition unit along a preset road-basis guide route. A disadvantage that lane guidance is not made until just before a guide intersection is avoided by setting the road-basis guide route for a section from the end of the lane networks to the vehicle position, indicated by the lane network data acquired not only when the vehicle approaches the guide intersection but also along the road-basis guide route.

### RELATED APPLICATIONS

The present application claims priority to Japanese Patent Appln. No. 2016-231446, filed Nov. 29, 2016, the entire disclosure of which is hereby incorporated by reference.

### BACKGROUND

### 1. Field of the Disclosure

The present disclosure relates to a guide route setting apparatus and a guide route setting method, and is particularly suitable for use in an apparatus for setting a lane-basis guide route.

### 2. Description of the Related Art

Generally, a navigation device has a route guidance function of, using map data; searching for a route with a smallest cost connecting from a present position to a destination by simulation such as Dijkstra's algorithm; and setting the searched route as a guide route. Then, the navigation device is configured to guide a driver to the destination by changing a color of a guide route from those of the other roads and drawing the guide route thickly on a screen map and showing a traveling direction when the vehicle approaches a guide intersection within a certain distance, during traveling of the vehicle.

Many navigation devices search for a road-basis guide route using road network data (data defining road connectivity). However, in a case where the driver is guided based on road-basis route information, if the driver mistakes the lane to be traveled at the guide intersection, the vehicle cannot travel along the guide route.

Incidentally, there is also a navigation device having a function of showing a lane to be traveled according to a traveling direction at a guide intersection. However, even in such a navigation device, guide routes are set on a road basis, and lane guidance is merely made based on lane information at guide intersections, regulation information indicating a direction along which a vehicle can travel at each lane, and traveling direction information indicated by the guide routes.

In this case, since lane guidance is not made until just before a guide intersection, a lane change to a lane shown by the navigation device may not be made in time depending on driving situations of the own vehicle and other vehicles at that time. Granted that the lane change is made in time, a forcible lane change may be required, which is not preferable. Especially, such a problem easily occurs in such a situation that a plurality of guide intersections is located successively at short distance intervals.

Note that navigation devices that search for a lane-basis guide route are also known (see, for example, JP 4700383 B2 and JP 3301386 B2). The navigation device disclosed in JP 4700383 B2 first searches for a guide route to a destination on a road basis using road links, and then searches for a lane-basis guide route using lane links corresponding to the searched road links.

The navigation device disclosed in JP 3301386 B2 makes the following travel guidance for guide branch points every time the navigation device approaches the guide branch points present on a guide route. That is, in a case where a route having a plurality of traveling lanes is included between a guide branch point and the vehicle position, a recommended traveling lane that can be traveled appropriately from the vehicle position to the route ahead of the guide branch point is determined by performing lane propagation processing. There are points at which lane situations change in order from the guide branch point as a starting point in the direction of the vehicle position. The lane propagation processing includes determining a recommended traveling lane after a lane situation change point for a recommended traveling lane before the lane situation change point in consideration of the lane situation change at the point.

Additionally, the following is disclosed in paragraph [0047] of JP 3301386 B2. Basically, a recommended traveling lane is determined on a guide branch point basis. However, in a case where a plurality of guide branch points is present close to each other, a recommended traveling lane to the route ahead of a guide branch point present in the forefront of the guide branch points is determined.

However, in JP 4700383 B2, although it is disclosed that a lane-basis guide route is searched using the lane links corresponding to the road links searched for the first time, a specific processing method for, in a case where there is a plurality of lanes, extracting a lane from the lanes and setting the lane as a guide route is not disclosed.

In addition, in the technique disclosed in JP 3301386 B2, in a case where a plurality of guide branch points is present close to each other, a recommended traveling lane is determined by collectively processing the guide branch points. However, if the vehicle does not approach the first guide intersection, a lane-basis guide route is not set. For this reason, it is difficult to solve the problem that a lane change to a lane shown at the first guide branch point cannot be made in time or a forcible lane change may be required.

### SUMMARY

The present disclosure has been made to address such a problem and an object thereof is to avoid situations in which it is difficult to travel along a guide route or it is necessary to forcibly change the lane by appropriately showing a driver the lane to be traveled along the guide route.

In order to address the above problem, the present disclosure is configured to follow lane networks in a direction of a vehicle position from a starting point at an end of the lane networks and to set lane networks connecting from the end to a lane where the vehicle position presents as a lane-basis guide route based on lane network data acquired along the guide route set on a road basis. Here, when the lane-basis route setting unit follows the lane networks from the end, the lane-basis route setting unit follows in the direction of the vehicle position from lane networks of the leftmost lane, returns to the end side until a lane changeable position in a case where a lane network which is followable is interrupted, and follows in the direction of the vehicle position from a lane network after a lane change to the right one being made at the returned position.

In forms of the present disclosure configured as described above, a lane-basis guide route is set for a section from the end of lane networks to the vehicle position, indicated by lane network data acquired not only when the vehicle approaches a guide branch point at a guide route set on a road basis but also along the road-basis guide route. Thereby, lane guidance provided just before a guide branch point is reduced, and it is possible to appropriately guide the driver to the lane to be traveled along the guide route. As a result, it is possible to avoid situations in which it is difficult to travel according to the guide route or it is necessary to forcibly change the lane.

### BRIEF DESCRIPTION OF THE DRAWINGS

FIG. 1 is a block diagram showing a functional configuration example of a guide route setting apparatus;

FIG. 2 is a view showing an example of lane networks acquired by a lane network data acquisition unit and lane groups set by a grouping unit; and

FIG. 3 is a flowchart showing an operation example of a guide route setting apparatus.

### DETAILED DESCRIPTION OF THE DRAWINGS

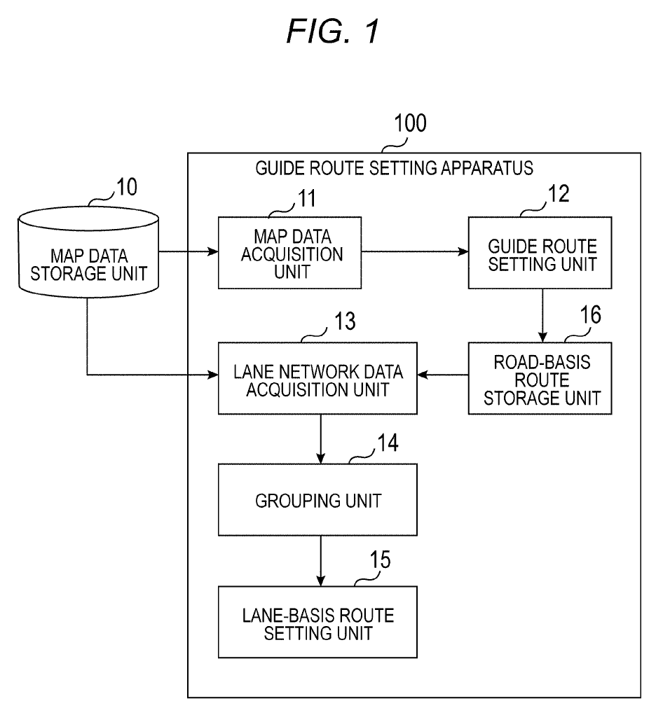

Hereinafter, embodiments and forms of the present disclosure will be described with reference to the drawings. FIG. 1 is a block diagram showing a functional configuration example of a guide route setting apparatus. As shown in FIG. 1, a guide route setting apparatus 100, as its functional configuration, may include a map data acquisition unit 11, a guide route setting unit 12, a lane network data acquisition unit 13, a grouping unit 14, and a lane-basis route setting unit 15. Furthermore, the guide route setting apparatus 100 may include a road-basis route storage unit 16 as a storage medium.

Each of the functional blocks 11 to 15 can be configured by hardware, a digital signal processor (DSP), or software. For example, when configured by software, each of the functional blocks 11 to 15 is actually configured by a central processing unit (CPU), a random access memory (RAM), and a read-only memory (ROM) of a computer, and is implemented by operating a program stored in a recording medium such as a RAM, a ROM, a hard disk, or a semiconductor memory.

The map data acquisition unit 11 acquires map data from a map data storage unit 10. This map data includes lane network data defining lane connectivity. The lane network data includes node data representing discrete positions set on each lane of the road and link data representing straight lines or curves connecting the nodes. Incidentally, the map data storage unit 10 may be provided in an in-vehicle device or may be provided in an external server accessible via the Internet.

The guide route setting unit 12 sets a guide route connecting from the present position to a destination using the map data acquired by the map data acquisition unit 11 and stores the data of the set guide route in the road-basis route storage unit 16. For example, similar to the route search function of a navigation device, the guide route setting unit 12 searches for a guide route with the smallest cost connecting from a present position acquired by a present position acquisition apparatus (not shown) to a destination set by a user and stores data of the searched guide route in the road-basis route storage unit 16.

The guide route set by the guide route setting unit 12 is a road-basis guide route. The road-basis guide route means a route showing which road to be traveled. In contrast, in a case where there is a plurality of lanes on a road, a route specifying even a lane to be traveled among the lanes is a lane-basis guide route. The guide route setting unit 12 sets not a lane-basis guide route but a road-basis guide route.

The lane network data acquisition unit 13 acquires lane network data from the map data storage unit 10 along the road-basis guide route already set by the guide route setting unit 12 (the guide route stored in the road-basis route storage unit 16). Here, for example, the lane network data acquisition unit 13 acquires lane network data included within a range of a predetermined distance from the vehicle position every predetermined travel distance. As one example, the lane network data acquisition unit 13 acquires, from the map data storage unit 10, lane network data included within a range of 10 km from the vehicle position every time the vehicle travels 100 m.

In this case, the lane network data acquisition unit 13 determines whether the vehicle position has moved 100 m ahead from a point where the lane network data acquisition unit 13 has acquired the lane network data last time based on a vehicle position measured by a vehicle position measurement device (not shown) and map data acquired by the map data acquisition unit 11. When determining that the vehicle position has moved 100 m, the lane network data acquisition unit 13 acquires the lane network data again.

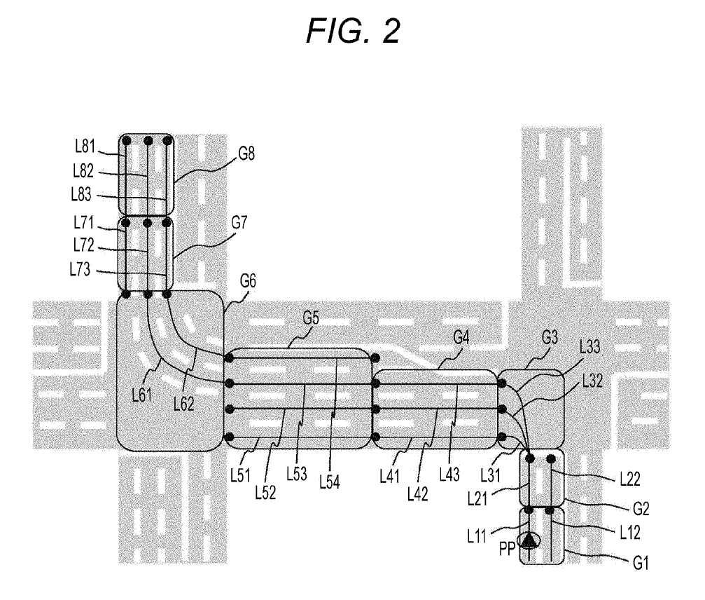

The grouping unit 14 groups a plurality of parallel lane networks into lane groups in units of links of the lane network data for road sections including a plurality of lanes in the road-basis guide route. FIG. 2 is a view showing an example of lane networks acquired by the lane network data acquisition unit 13 and lane groups set by the grouping unit 14. Here, the situation at two successive guide intersections is shown.

As shown in FIG. 2, the lane network data acquisition unit 13 acquires lane network data of lanes on which the vehicle can travel, among the lane network data included within a range of 10 km from the present position PP to the destination side. That is, since there are two lanes of the road where the vehicle position PP presents, two links L11 and L12 corresponding to the two lanes are acquired. Regarding the following links, two links L21 and L22 to be connected to the previous links L11 and L12 respectively are acquired.

The section ahead of the links L21 and L22 corresponds to a section for turning left at the first guide intersection. There are three lanes of the road on an exit side of this guide intersection. Then, the leftmost lane of the road on an entry side of this guide intersection is a left turn lane so that the vehicle can proceed to any lane of the road on the exit side. Thus, at the first guide intersection, three links L31, L32, and L33 to be connected from the link L21 on the entry side to three links L41, L42, and L43 on the exit side, respectively are acquired.

Following the three links L31, L32, and L33, three pairs of the links L41, L42, and L43 and L51, L52, and L53, respectively are acquired as data up to the second guide intersection. The three pairs of the links are sequentially connected to the links L31, L32, and L33. Incidentally, a right turn lane of a road on an entry side of the second guide intersection is added. Thus, the link L54 of the right turn lane in parallel with the above-mentioned three links L51, L52, and L53 is also acquired.

A section ahead of the links L51, L52, L53, and L54 corresponds to a section for turning right at the second guide intersection. There are three lanes of the road on an exit side of this guide intersection, and a lane to which the vehicle can proceed is regulated by the right turn. That is, lanes are drawn so as to proceed from the right two lanes of the road on the entry side of the guide intersection to the right two lanes of the road on the exit side, and the vehicle is regulated so that the vehicle travels along these lanes. Thus, at the second guide intersection, two links L61 and L62 to be connected from the links L53 and L54 of the right two lanes on the entry side to links L72 and L73 of the right two lanes on the exit side are acquired.

Following the two links L61 and L62, two pairs of the links L72 and L73 and L82 and L83, respectively are acquired. The two pairs of the links are sequentially connected to the links L61 and L62. Links L71 and L81 in parallel with these links are also acquired. This is because the leftmost lane is also a lane on which the vehicle can travel by changing the lane after the right turn to either of the right two lanes. Although a section ahead of the links L81, L82, and L83 is not shown, the links of the lane network data are acquired in the similar way as described above.

The grouping unit 14 groups a plurality of parallel lane networks into lane groups in units of links for the lane network data acquired as described above. In the example of FIG. 2, in order from the vehicle position PP, the grouping unit 14 groups the two lane networks including the links L11 and L12, the two lane networks including the links L21 and L22, and the three lane networks including the links L31, L32, and L33 into a first lane group G1, a second lane group G2, and a third lane group G3, respectively.

The lane-basis route setting unit 15 follows lane networks in the direction of the vehicle position from a starting point at the end of the lane networks and sets lane networks connecting from the end to the lane where the vehicle position presents a lane-basis guide route based on the lane network data (grouped by the grouping unit 14) acquired by the lane network data acquisition unit 13. Specifically, the lane-basis route setting unit 15 sequentially selects links corresponding to any of the lanes for the respective lane groups, so that the lane-basis route setting unit 15 follows the lane networks to the vehicle position side.

Here, when following the lane networks from the end, the lane-basis route setting unit 15 follows in the direction of the vehicle position from the lane networks of the leftmost lane. Then, when the lane network which is followable is interrupted, the lane-basis route setting unit 15 returns to the end side until a lane changeable position, and, after changing the lane to the right one at the returned position, follows in the direction of the vehicle position from a lane network after the lane change.

Note that, in the process of following the lane networks from the end to the vehicle position side, a lane network corresponding to the rightmost lane may be selected. When a lane network which is followable from the lane networks of the rightmost lane is interrupted, the lane-basis route setting unit 15 returns to the end side until a lane changeable position, and, after changing the lane to the left one at the returned position, follows in the direction of the vehicle position from a lane network after the lane change.

The content of the process performed by the lane-basis route setting unit 15 will be described with reference to FIG. 2. Here, it is assumed that the lane networks including the links L81 to L83 belonging to a lane group G8 shown in FIG. 2 corresponds to the end of the lane network data acquired by the lane network data acquisition unit 13.

First, the lane-basis route setting unit 15 selects the link L81 corresponding to the leftmost lane among the links L81 to L83 belonging to the lane group G8 at the end, and follows lane networks from the link L81 in the direction of the vehicle position. In the example of FIG. 2, with respect to a lane group G7 immediately before the lane group G8 (the vehicle position side), the lane-basis route setting unit 15 selects the link L71 to be connected to the link L81.

Further, with respect to a lane group G6 immediately before the lane group G7, the lane-basis route setting unit 15 selects a link connected to the link L71 and tries to follow lane networks in the direction of the vehicle position, but a lane network which is followable is interrupted ahead of the link L71. That is, a link connected to the link L71 is not acquired by the lane network data acquisition unit 13.

In this case, the lane-basis route setting unit 15 acquires information on the lane group G7 to which the link L71 belongs, and checks whether the vehicle can change the lane from the link L72 on the right lane to the link L71. If the vehicle cannot change the lane, the lane-basis route setting unit 15 returns to the end side until a position where the vehicle can change the lane, in the example of FIG. 2, a position of a node connecting the link L71 and the link L81, and if the vehicle can change the lane from the link L82 to the link L81 at the returned position, the vehicle changes the lane to the right one. That is, the lane-basis route setting unit 15 selects the link L72 instead of the link L71 and follows lane networks in the direction of the vehicle position from the link L72 after the lane change.

Here, with respect to the lane group G6 immediately before the lane group G7, the lane-basis route setting unit 15 selects the link L61 as a link connected to the link L72. Further, with respect to lane groups G5 to G1 on a side of the vehicle position rather than the lane group G6, the lane-basis route setting unit 15 sequentially selects the links L53, L43, L33, L21, and L11 sequentially connected from the link L61, so that the lane-basis route setting unit 15 follows the lane networks to the vehicle position PP.

As described above, if the lane-basis route setting unit 15 can follow lane networks to the lane where the vehicle position PP presents, the lane-basis route setting unit 15 sets the lane networks connected by the links selected for the respective groups from the lane group G8 at the end to the lane group G1 where the vehicle position PP presents, as a lane-basis guide route. In this example, the lane-basis route setting unit 15 sets the lane networks connected in the following order from the vehicle position PP: the links L11, L21, L33, L43, L53, L61, L72, and L82, as a lane-basis guide route.

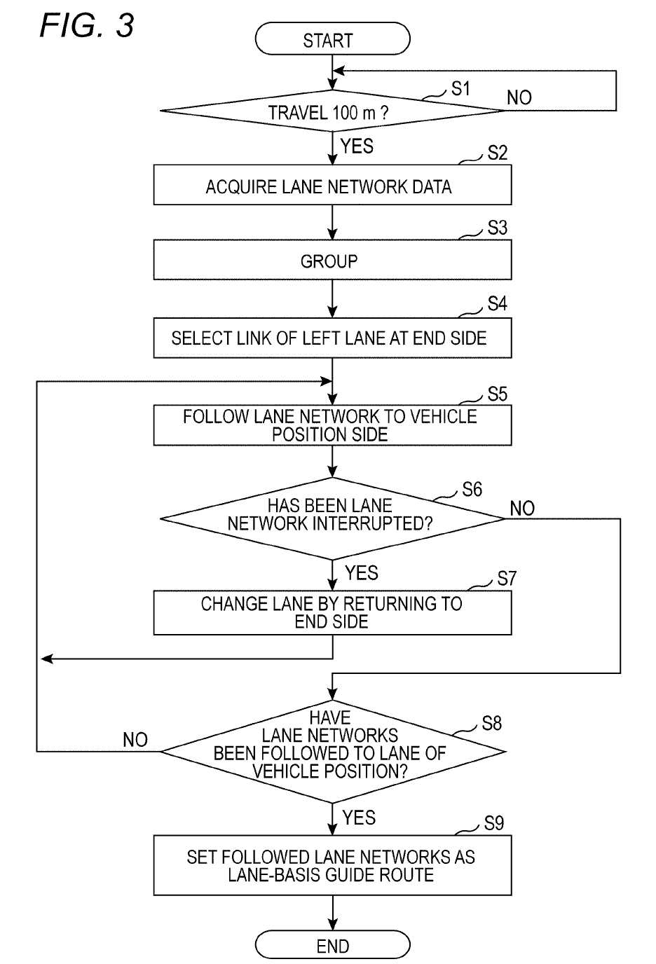

FIG. 3 is a flowchart showing an operation example of the guide route setting apparatus 100 configured as described above. The flowchart shown in FIG. 3 is started, for example, when a user instructs the guide route setting unit 12 to set a lane-basis guide route after the guide route setting unit 12 sets a road-basis guide route.

First, the lane network data acquisition unit 13 determines whether a vehicle position has moved 100 m ahead from a point where the lane network data acquisition unit 13 has acquired the lane network data last time (step S1). Then, when determining that the vehicle position has moved 100 m ahead, the lane network data acquisition unit 13 acquires the lane network data included within a range of 10 km from the vehicle position along the guide route stored in the road-basis route storage unit 16 (step S2).

Next, the grouping unit 14 groups a plurality of parallel lane networks into lane groups in units of links of the lane network data (step S3). Next, the lane-basis route setting unit 15 selects a link corresponding to the leftmost lane from the lane group at the end of the lane networks based on the lane network data acquired by the lane network data acquisition unit 13 (step S4). Then, the lane-basis route setting unit 15 follows lane networks in the direction of the vehicle position from the selected leftmost link (step S5).

Here, the lane-basis route setting unit 15 determines whether a lane network which is followable to the vehicle position side is interrupted (step S6). When the lane network is interrupted, the lane-basis route setting unit 15 returns to the end side until a lane changeable position, and selects a link again so as to change the lane to the right one at the returned position (step S7). Thereafter, the process returns to step S5, and the lane-basis route setting unit 15 follows lane networks in the direction of the vehicle position from the link after the lane change.

When determining that the lane network which is followable to the vehicle position side is not interrupted in step S6, the lane-basis route setting unit 15 determines whether to follow lane networks to the lane where the vehicle position presents (step S8). If the lane networks have not yet been followed to the vehicle position, the process returns to step S5.

On the other hand, when the lane networks can be followed to the lane where the vehicle position presents, the lane-basis route setting unit 15 sets the lane networks connected by the links selected for the respective groups from the lane group at the end to the lane group where the vehicle position presents, as a lane-basis guide route (step S9), and the process of the flowchart shown in FIG. 3 is ended.

As described above in detail, in some implementations, the lane network data acquisition unit 13 acquires, from the map data storage unit 10, the lane network data included within the range of a predetermined distance from the vehicle position (for example, 10 km) along the guide route set on a road-basis by the guide route setting unit 12. Then, the lane-basis route setting unit 15 follows lane networks in the direction of the vehicle position from the end of the lane networks as a starting point and sets lane networks connecting from the end to the lane where the vehicle position presents as a lane-basis guide route based on the acquired lane network data.

In implementations such as those configured as described above, the guide route setting unit 12 can set a road-basis guide route for a section from the end of the lane networks to the vehicle position, indicated by the lane network data acquired not only when the vehicle approaches the guide intersection on the guide route set on a road-basis but also by the lane network data acquisition unit 13.

Thereby, lane guidance provided just before the guide intersection is reduced, and it is possible to appropriately guide the driver to a lane to be traveled along the guide route. As a result, it is possible to avoid situations in which it is difficult to travel along the guide route or it is necessary to forcibly change the lane just before turns because the driver cannot change the lane to a lane that should be originally traveled.

Further, in the implementations described above, there is also an advantage that it is possible to set a lane-basis guide route on which the vehicle can travel efficiently with low fuel consumption, such that a wasteful lane change is not made. That is, as shown in FIG. 2, as a guide route for turning left at the first guide intersection, a lane network is set by the link L33 connected from the link L21 corresponding to the left turn lane of the road on the entry side of the first guide intersection to the link L43 of the road on the exit side of the first guide intersection. This link L43 is a link leading to a right turn lane of the road on the entry side of the second guide intersection. Thus, after passing through the first guide intersection, there is no need to change the lane until the second guide intersection.

Incidentally, in the implementations described above, when the lane network which is followable to the vehicle position side is interrupted, the example of returning to the end side until the lane changeable position and changing the lane with no exception has been described. However, the present disclosure is not limited thereto. For example, when it is possible to follow the lane networks to the lane group where the vehicle position presents, but the lane networks are not connected to the lane network of the lane where the vehicle position presents, it is determined whether the lane change is possible in the lane group of the vehicle position. Then, when the lane change is possible, the lane-basis route setting unit 15 sets the followed lane network as a lane-basis guide route, and when the lane change is not possible, a lane change may be made by returning to the end side until the lane changeable position.

In this way, even if the vehicle does not travel on a lane necessary for turning right or left at the following guide intersection when the vehicle travels a predetermined distance and the lane network data acquisition unit 13 acquires a lane network, it is possible to avoid a risk that the vehicle cannot travel along the route by setting a route for a lane change in the lane group to which the vehicle position belongs. Thus, it is possible to set the lane-basis guide route on which the vehicle can travel with low fuel consumption.

Furthermore, in the implementations described above, the example in which the lane network data acquisition unit 13 acquires the lane network data included within a range of the predetermined distance from the vehicle position every predetermined travel distance has been described. However, the present disclosure is not limited thereto. For example, the lane network data acquisition unit 13 may acquire the lane network data on the whole course of the road-basis guide route. A guide route with the smaller number of lane changes in the course to the destination can be set by setting a lane-basis guide route by acquiring the lane network data over the whole course. In that case, depending on the location of the destination, processing of following the lane networks from the end may be started from the rightmost lane.

Further, in the implementations described above, an example has been described in which the lane networks of a plurality of lanes are grouped in units of links. However, the present disclosure is not limited thereto. For example, the lane networks may be grouped with nodes whose attributes such as the number of lanes and traffic regulation change as boundaries. That is, various types of attribute information such as the number of lanes, traffic regulation, and whether it is an intersection are given to each node of the lane network data. The lane networks may be grouped with nodes in which at least one of the various types of attribute information changes as a boundary from among a plurality of nodes successively arranged from the vehicle position to the end of the lane networks. When considering traffic regulation, lanes for which lane regulation is implemented are treated as lanes that cannot enter or leave and lanes that cannot be changed.

In this case, one or more nodes are included in one lane group, and the attributes of those nodes are the same. In addition, one or more links are included in one lane group, and those links can be treated as one lane network collectively. In this way, when following lane networks from the end of the lane networks to the vehicle position, the number of lane networks to be selected decreases, so it is possible to set the lane-basis guide route in a shorter time.

When grouping lane networks of a plurality of lanes in units of links, grouping of the lane networks by the grouping unit 14 is not necessarily performed.

Guide route setting apparatus such as those described above can be applied to a navigation device. The guide route setting apparatus such as those described above can be applied to automated driving control for controlling the steering along a guide route without manually operating the steering wheel.

The embodiments and implementations described above are merely exemplary for accomplishing the present disclosure, and the technical scope of the present disclosure should not be interpreted as limited. That is, the present disclosure can be variously accomplished without departing from its spirit or its main feature.

It is therefore intended that the foregoing detailed description be regarded as illustrative rather than limiting, and that it be understood that it is the following claims, including all equivalents, that are intended to define the spirit and scope of this disclosure.

What is claimed is:

1. A guide route setting apparatus comprising:
a lane network data acquisition unit configured to acquire lane network data defining lane connectivity along a preset road-basis guide route; and
a lane-basis route setting unit configured to follow lane networks in a direction of a vehicle position from a starting point at an end of the lane networks, and to set lane networks connecting from the end to a lane where the vehicle position presents a lane-basis guide route based on the lane network data acquired by the lane network data acquisition unit;
wherein when the lane-basis route setting unit follows the lane networks from the end, the lane-basis route setting unit is configured to follow in the direction of the vehicle position from lane networks of the leftmost lane, to return to the end side until a lane changeable position in a case where a lane network which is followable is interrupted, and to follow in the direction of the vehicle position from a lane network after a lane change to the right one being made at the returned position.

2. The guide route setting apparatus according to claim 1, wherein the lane network data acquisition unit is configured to acquire lane network data on the whole course of the road-basis guide route.

3. The guide route setting apparatus according to claim 1, wherein the lane network data acquisition unit is configured to acquire lane network data included within a range of a predetermined distance from the vehicle position for each predetermined travel distance.

4. The guide route setting apparatus according to claim 1, further comprising:
a grouping unit configured to group a plurality of parallel lane networks into lane groups in units of links of the lane network data for a road section including a plurality of lanes in the road-basis guide route;
wherein the lane-basis route setting unit is configured to select links corresponding to any of the lanes for the respective lane groups set by the grouping unit, so that the lane-basis route setting unit follows the lane networks in the direction of the vehicle position sequentially.

5. The guide route setting apparatus according to claim 4, wherein in a case where the lane-basis route setting unit can follow the lane networks until a lane group where the vehicle position is present but the lane networks are not connected to a lane network of a lane where the vehicle position is present, the lane-basis route setting unit is configured to:
determine whether a lane change is possible in the lane group of the vehicle position,
set the followed lane networks as the lane-basis guide route when a lane change is possible, and
change the lane by returning to the end side until a lane changeable position when a lane change is not possible.

6. The guide route setting apparatus according to claim 4, wherein the grouping unit is configured to group the lane networks with nodes, as a boundary, having different attribute information content from that of a plurality of nodes successively arranged along the lane networks instead of grouping the lane networks in units of links.

7. A method for setting a lane-basis guide route in an in-vehicle computer, the method comprising:
a first step of a lane network data acquisition unit in the computer acquiring lane network data defining lane connectivity along a preset road-basis guide route; and
a second step of a lane-basis route setting unit in the computer following lane networks in a direction of a vehicle position from a starting point at an end of the lane networks and setting lane networks connecting from the end to a lane where a vehicle position presents a lane-basis guide route;
wherein in the second step, when the lane-basis route setting unit follows the lane networks from the end, the lane-basis route setting unit follows in the direction of the vehicle position from lane networks of the leftmost lane, returns to the end side until a lane changeable position in a case where a lane network which is followable is interrupted, and follows in the direction of the vehicle position from a lane network after a lane change to the right one being made at the returned position.
